(19) United States
(12) Patent Application Publication
(10) Pub. No.: US 2021/0182392 A1
(43) Pub. Date: Jun. 17, 2021

(54) Method for Detecting and Defeating Ransomware

(71) Applicant: Rangone LLC, Arlington, VA (US)

(72) Inventor: Robert Stephan HARGROVE, Punta Gorda, FL (US)

(73) Assignee: Rangone, LLC, Arlington, VA (US)

(21) Appl. No.: 17/113,279

(22) Filed: Dec. 7, 2020

Related U.S. Application Data
(60) Provisional application No. 62/949,107, filed on Dec. 17, 2019.

(51) Int. Cl. G06F 21/56; G06F 21/57; G06F 21/51

(52) U.S. Cl. CPC G06F 21/565; G06F 21/575; G06F 2221/034; G06F 21/51; G06F 2221/2115; G06F 21/577

(57) ABSTRACT

Embodiments of the present invention are directed to providing a method for detecting and defeating ransomware on a computing device by monitoring selected “bait” files for suspicious file accessing activity. Whenever a bait file is accessed by any software, embodiments of the invention determine whether the accessing software is potentially ransomware. If ransomware is suspected, embodiments of the invention may halt execution of the suspected ransomware and may also take other remedial measures to issue warning notifications and to limit further damage to unaffected data files of the computing device. Such other remedial measures may include removing executable files associated with the suspected ransomware software, shutting down the computing device, and/or setting the computing device to reboot into a safe mode so that further ransomware removal steps can be taken.

### CROSS-REFERENCE TO RELATED APPLICATIONS

This application claims priority under 35 U.S.C. § 119(e) to U.S. Provisional Patent Application No. 62/949,107, entitled “Method for Preventing Ransomware from Encrypting Files,” filed on Dec. 17, 2019.

### FIELD OF THE INVENTION

Embodiments of the present invention relate to a new and improved method for detecting when a software program executing on a computing device, including a previously unknown software program, is potentially ransomware. More particularly, embodiments of the present invention provide a new and improved method for responding to a detection of potential ransomware and/or data exfiltration malware, by taking remedial actions.

### BACKGROUND

Ransomware (including data exfiltration malware) is malicious computer software designed by an adversary that renders files on a computing device inaccessible or otherwise unusable to a user-victim, or exfiltrates the files, with the primary purpose of obtaining monetary gain. Certain exfiltration variants of ransomware may exfiltrate a victim's data files and then threaten to publish the data unless payment is made. The adversary's main objective is monetary gain via extortion, usually by demanding that the victim pay a monetary ransom to regain access to their data. Typically, when the victim pays the ransom, the adversary will provide a decryption key and/or instructions to allow the victim to recover or decrypt their data files. Some adversaries may not always provide a decryption key, however, and will simply keep the money. Ransomware may spread quickly through a computer network and across networks to infect multiple computing devices, further compounding the problem and raising ransom costs. Entire companies, organizations, or agencies can remain shut down for days or even weeks due to a ransomware attack.

Citing FBI statistics, former U.S. Deputy Attorney General Rod J. Rosenstein stated during an October 2017 Cambridge Cyber Summit, “The cost of ransomware attacks is staggering. Ransomware infects more than 100,000 computers around the world every day and payments are approaching $1 billion” See https://www.govtech.com/security/Inside-the-Profitable-Underworld-of-Ransomware.html.

According to Aithroity.com (see https://www.aithority.com/computing/study-reveals-ransomware-is-a-top-business-concern-during-covid-19-remote-work-period!), “The majority of respondents (68.5%) claimed that ransomware attacks have cost their companies between $100,000-$500,000 while 19.7% reported a loss of more than $500,000, including ransomware payment, downtime and lost business.”

Other estimates expect the global cost of ransomware to reach $20 billion by 2021.

Of major concern to society is the impact of ransomware on critical infrastructure, such as the healthcare industry, financial institutions, educational institutions, transportation, energy, water, federal, state, and local governments.

To defend against ransomware attacks, several approaches have been tried, but they have been only partially successful at best. They include the following:

Some anti-ransomware technologies thwart ransomware by identifying signatures in computer files. Signatures consist of unique strings of code or data taken from previously identified ransomware samples. The signatures are compared against new programs attempting to execute on a computer to see if there is a match. If a match is found, the program is assumed to be ransomware. It is then halted, isolated, and/or quarantined, preventing (further) infection. These technologies are only partially successful, in that they protect against ransomware that has already been identified and for which a signature has been created. These technologies do not address the problem of new ransomware or even modified variants of existing ransomware. Additionally, poorly designed signatures may cause a false positive match, where antivirus software will mistakenly remove or quarantine essential operating system files or programs.

Microsoft Windows uses a Volume Shadow Copy to store backup copies of data which can be used to recover files after a ransomware attack. However, sophisticated versions of ransomware are often aware of the backup files and target them first, thereby negating their usefulness.

In Microsoft Windows 10, the Windows Defender product lets a user add specific directories or files to a Controlled Folder Access area to protect them from ransomware access, but this approach requires user knowledge and intervention and does not protect all of the files on the system.

Other methods to achieve recovery of encrypted files include the use of decryption tools. These tools are developed by antivirus companies or other good Samaritans. Early ransomware variants were susceptible to reverse engineering of the encryption process, making decryption tools possible. However, newer ransomware variants have more complex and sophisticated algorithms and use new methods that deter and limit the usefulness of such decryption tools.

Complete and current system backups can be used to restore systems and recover data after an attack. But this method is only useful if an investment is made and the backups are maintained and updated. Even then, it takes time and personnel to recover or rebuild systems, and this method does nothing to address the problem of an adversary publicly releasing exfiltrated data or requiring a ransom to be paid to prevent that release.

Thus, the currently known methods of detecting and quarantining ransomware, or currently known methods of preventing files from encryption, are at best only marginally effective. This is why ransomware remains a globally persistent problem.

### SUMMARY OF THE INVENTION

This summary is provided to introduce certain concepts in a simplified form that are further described below in the Detailed Description. This summary is not intended to identify key features or essential features of the claimed subject matter, nor is it intended to limit in any way the scope of the claimed invention.

To address the globally persistent problem of ransomware, embodiments of the invention exploit a behavior that is common to all ransomware: it reads and encrypts data files. Thus, rather than monitor and/or examine the contents of executable programs looking for signatures or other evidence of known ransomware, embodiments of the invention lay a trap and then wait for ransomware to take the bait. When the bait is taken—that is, when certain “bait” files are accessed by any software—embodiments of the invention quickly determine whether the accessing software is potentially ransomware. If ransomware is suspected, embodiments of the invention may halt execution of the ransomware software and may also take other remedial measures to issue warning notifications and to limit further damage to unaffected data files of the computing device. Such other remedial measures may include removing executable files associated with the suspected ransomware software, shutting down the computing device, and/or setting the computing device to reboot into a safe mode so that further ransomware removal steps can be taken.

The above summary of embodiments of the present invention has been provided to introduce certain concepts that are further described below in the Detailed Description. The summarized embodiments are not necessarily representative of the claimed subject matter, nor do they span the scope of features described in more detail below. They simply serve as an introduction to the subject matter of the various claimed inventions.

### BRIEF DESCRIPTION OF THE DRAWINGS

So that the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary embodiment of a method that can be used to detect and respond to a ransomware attack on a computing device, in accordance with the present invention.

FIG. 2 is a block diagram of an exemplary embodiment of a computing device, in accordance with the present invention.

### DESCRIPTION OF THE EMBODIMENTS

Embodiments of the present invention will be described with reference to the accompanying drawings, wherein like parts are designated by like reference numerals throughout, and wherein the leftmost digit of each reference number refers to the drawing number of the figure in which the referenced part first appears.

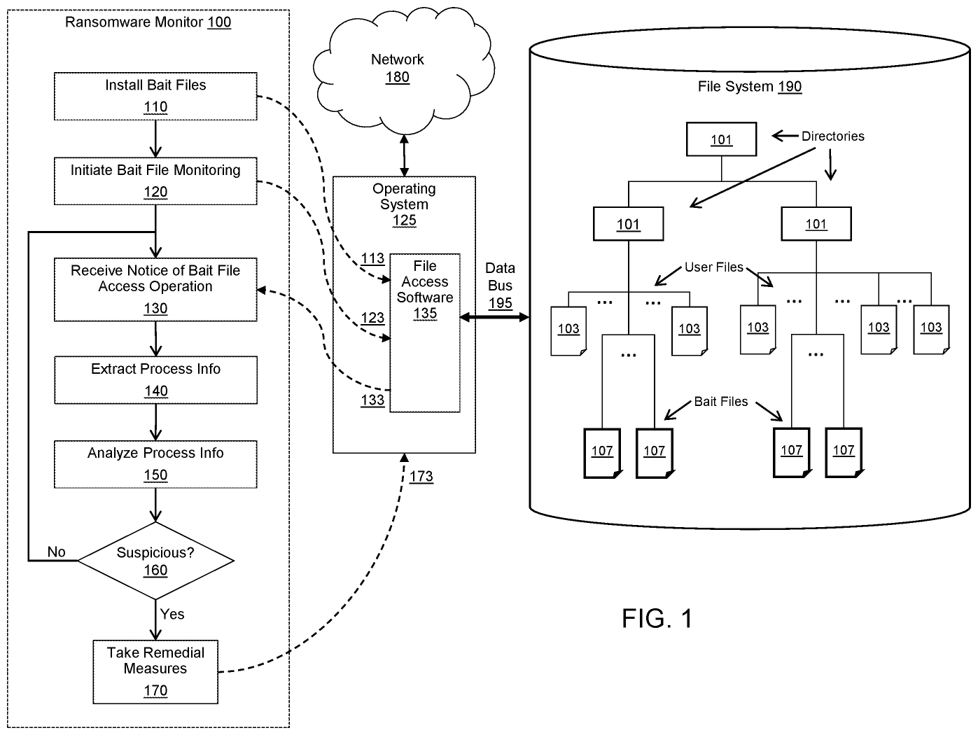

FIG. 1 illustrates an exemplary embodiment of a method that can be used to detect and respond to a ransomware attack on a computing device, in accordance with the present invention.

Embodiments of the invention comprise a Ransomware Monitor 100 executing on a computing platform, where the computing platform includes an Operating System 125, a File System 190, and an optional connection to a Network 180.

Operating System 125 can comprise any operating system familiar to one of ordinary skill in the art of software engineering and/or computer science, including, for example, Unix, A/UX, Linux, LynxOS, AIX, DOS, Windows, Windows NT, iOS, iPadOS, watchOS, tvOS, macOS, Android, Chrome OS, BlackBerry Tablet OS, RT-11, VMS, and all versions and variations of those examples.

File System 190 can comprise any method for cataloging, arranging, and/or accessing computer files on a storage medium that is familiar to one of ordinary skill in the art of software engineering and/or computer science, including, for example, the Unix file system, APFS, HFS, HFS+, HPS, FAT, FAT32, NTFS, and HPFS.

Computer files in File System 190 may include User Files 103 and Bait Files 107 (collectively and/or alternatively “Files 103 and/or 107”), which may be organized into a hierarchy of Directories 101. As is known in the art, a Directory 101 may be implemented as a special type of file. As will be explained in further detail below, User Files 103 and Bait Files 107 are both normal computer files. The difference is that a User File 103 is typically created by a user or user-controlled software, where a Bait File 107 is typically created by Ransomware Monitor 100. Otherwise, Bait Files 107 may appear to be User Files 103.

Software programs, including Ransomware Monitor 100, may interact with Files 103 and/or 107 in File System 190 via File Access Software 135, which is typically provided with and/or embedded within Operating System 125. Such File Access Software 135 may include file accessing routines and/or methods 113 and/or 123, which allow software programs such as Ransomware Monitor 100 to create, read, write, and delete Files 103 and/or 107 within File System 190, and to obtain and modify information about Files 103 and/or 107. File Access Software 135 may also include file monitoring routines and/or methods 133, which provide notifications to software programs (like Ransomware Monitor 100) that certain events have occurred with respect to a given File 103 and/or 107, or with respect to a Directory 101.

File Access Software 135 may interact with File System 190 via Data Bus 195.

As is known in the art, File System 190 (including its Directories 101 and Files 103 and/or 107) may reside on any number of known storage media types, including magnetic disks, optical disks, tape, tape drives, thumb drives, solid state drives, network file systems, and the like.

As is known in the art, the capabilities and/or subcomponents of File Access Software 135 and File System 190 may be split or shared. That is, some subcomponents of File Access Software 135 may be implemented within File System 190, and vice versa.

### Bait Files

Once the software comprising Ransomware Monitor 100 has been installed on a computing platform and begins executing, it may install or identify a number of Bait Files 107 within File System 190 by invoking file accessing routines and/or methods 113 within File Access Software 135.

A Bait File 107 is a computer file that Ransomware Monitor 100 can monitor for suspicious activity. A Bait File 107 may be created from scratch at Step 110 (“Install Bait Files”) by invoking file accessing routines and/or methods 113 within File Access Software 135. A Bait File 107 may also be an existing User File 103 that is identified as a Bait File 107. A Bait File 107 may also be any other file in File System 190, including executable files, operating system files, application files, user files, and/or data files. To create a Bait File 107 from scratch or to identify a User File 103 (or any other file) as a Bait File 107, Ransomware Monitor 100 may invoke file accessing routines and/or methods 113 within File Access Software 135 to perform the required file creation functions and/or data writing functions.

Once a file is created or identified as a Bait File 107, its existence and status as a bait file may be recorded within Ransomware Monitor 100.

Generally, Bait Files 107 may be created, identified, and/or distributed throughout File System 190 in various locations, including on any hard drive, file system, file partition, directory structures, or other similar locations where files are stored on a computer. Bait Files 107 may appear to be normal files that are typically found on computers. For example, a Bait File 107 may be a Microsoft Word document, an Excel spreadsheet, an Adobe .pdf file, an image file such as a .jpg or .png file, a text file, or a database file, etc. A Bait File 107 may also be an executable file or any other computer file that is installed or found within File System 190 and monitored by Ransomware Monitor 100.

Bait Files 107 are special in the sense that they will not normally be accessed (for example, via file accessing routines and/or methods 113 that provide read, write, and/or delete capabilities for File Access Software 135) by any program, with the exception of applications such as backup software or programs that are well-known and/or whitelisted by Ransomware Monitor 100 as not presenting a ransomware threat or not being otherwise suspicious.

To appear normal, Bait Files 107 may preferentially contain appropriate file header information, so they can be identified and verified to have content that is correspondingly appropriate to their file name, including their file name suffix. For example, a Microsoft Word file, which may have a file name suffix of “.doc” or “.docx” may typically contain certain file header information that complies with the format that the Microsoft Word application requires. In other words, a Bait File 107 that has a “.docx” extension or suffix, should preferentially contain content, including file header information, that makes the file look like an actual Microsoft Word data file.

Preferentially, Bait Files 107 may have different create/modify time stamps.

Preferentially, Bait Files 107 may vary in size.

Preferentially, different Bait Files 107 may contain different content and different amounts of content.

Preferentially, the names of Bait Files 107 may be as realistic as possible and not comprise random characters.

Bait Files 107 may be hidden or invisible to a normal user looking at a Directory 101 within File System 190 via a command line prompt or a graphical user interface.

Preferentially, Bait Files 107 may be visible programmatically to executing software, so that a ransomware application will be able to “see” the Bait Files 107 when it obtains a file listing or a directory listing from the File Access Software 135 of Operating System 125.

Preferentially, Ransomware 100 may delete and recreate Bait Files 107 at random intervals, thereby making them more difficult to be discovered by ransomware.

Bait Files 107 may be positioned within File System 190 so they will be the first files, or nearly the first files, in a file listing that a ransomware application obtains from File Access Software 135 of Operating System 125.

Bait Files 107 may also be positioned randomly within File System 190.

Bait Files 107 that occupy the same Directory 101 may vary by file type.

The number of Bait Files 107 that occupy different Directories 101 may vary.

### Monitoring Bait Files

Once Bait Files 107 have been created, identified, and/or distributed within the File System 190 at Step 110 (Install Bait Files), Ransomware Monitor 100 may perform Step 120 (Initiate Bait File Monitoring). At Step 120, Ransomware Monitor 100 may invoke file monitoring routines and/or methods 123 within File Access Software 135 to initiate file access monitoring on at least one of the Bait Files 107.

Operating system file monitoring routines and/or methods 123 are known by those having ordinary skill in the art of software engineering or computer science. Such routines and/or methods include inotify(7),fanotify(7), and related or similar file system calls within the Linux and/or Unix operating system(s). Using these and other similar operating-system-supplied file monitoring routines and/or methods 123, the software operating within Ransomware Monitor 100 may execute Step 120 by invoking a file monitoring routine and/or method 123 within File Access Software 135 to cause the File Access Software 135 and/or the Operating System 125 to monitor a given Bait File 107 for any attempt to read, write, delete, or otherwise access or probe the Bait File 107.

Once Step 120 has been completed for at least one of the Bait Files 107, Ransomware Monitor 100 may then enter Step 130 (Receive Notice of Bait File Access Operation) to wait for a Bait File 107 to be accessed.

If the File Access Software 135 (via file monitoring routines and/or methods such as inotify(7),fanotify(7), and related file system calls) determines that a Bait File 107 has just recently been or is currently being accessed by another program, File Access Software 135 may generate a notification event 133, which may be received by the Ransomware Monitor 100 at Step 130.

Alternatively, at Step 130, after Ransomware Monitor 100 has invoked a file monitoring routine and/or method 123 within File Access Software 135 to cause the File Access Software 135 and/or the Operating System 125 to monitor a given Bait File 107, in certain implementations of the file monitoring routines and/or methods 123, Ransomware Monitor 100 may execute a read( ) operation 133 on the monitored Bait File 107. The read( )operation 133 may then block (i.e., stall or hang) until one of several possible conditions is met. One of those conditions may be an attempt to access the Bait File 107 by another program.

Thus, depending on the capabilities supplied by the File Access Software 135 and/or the Operating System 125, Ransomware Monitor 100 may receive notice of a possible attempt to access a Bait File 107, either by receiving a notification event 133 relating to the Bait File 107, by completing a read( )operation 133 on the Bait File 107, or by any other file access notification method or event 133 known by those skilled in the art.

Still at Step 130, Ransomware Monitor 100 may receive data from File Access Software 135 and/or the Operating System 125 associated with notification event 133 or read( )operation 133. The received data may include the process identifier (or pid) of the program that accessed the Bait File 107.

### Analyzing a Potentially Suspicious Program

At Step 140, Ransomware Monitor 100 may extract the pid of the program that accessed the Bait File 107 from the data received at Step 130 from the notification event 133 or read( ) operation 133. Using the pid, Ransomware Monitor 100 may obtain information about the program that accessed the Bait File 107 using methods known by those skilled in the art. For example, Ransomware Monitor 100 may obtain the filename of the program that accessed the Bait File 107. Using information such as the filename of the program that accessed the Bait File 107, Ransomware Monitor 100 may analyze that information at Step 150 to determine whether the program that accessed the Bait File 107 should be considered suspicious. For example, Ransomware Monitor 100 may use the filename of the program that accessed the Bait File 107 as an index into a database of approved or authorized (i.e., “whitelisted”) programs that are deemed unsuspicious. Such whitelisted programs may be allowed to continue executing. Examples of whitelisted programs include known operating system programs such as backup and restore programs. Other examples of whitelisted programs include well-known software such as Microsoft Word, verified user-installed software, and the like. If, at Step 160, the filename of the program that accessed the Bait File 107 is found in the database of whitelisted and therefore unsuspicious programs, Ransomware Monitor 100 may return to Step 130 to monitor the Bait File 107 for other potentially suspicious access operations.

Otherwise, at Step 170, the program that accessed the Bait File 107 at Step 130 may be considered suspicious and therefore remedial measures may be taken.

At Step 170, Ransomware Monitor 100 may increase its process priority and lower the priority of all other processes, to effectively block or significantly slow execution of the suspicious program that accessed the Bait File 107 while additional remedial measures are undertaken.

At Step 170, remedial measures may include using the pid of the program that accessed the Bait File 107 to invoke routines or methods 173 within Operating System 125 to “kill” or terminate the suspicious program that accessed the Bait File 107.

At Step 170, Ransomware Monitor 100 may also invoke routines or methods 173 within Operating System 125 to kill or terminate all parent processes of the suspicious program, or may kill or terminate all processes in the same process group as the program that accessed the Bait File 107.

At Step 170, Ransomware Monitor 100 may also invoke routines or methods 173 within Operating System 125 to issue warning messages and/or notifications reporting the suspicious program, where the warning message and/or notification may include the name of the process associated with the suspicious program and optionally its filename. At Step 170, the warning message and/or notification may be written to a log file, displayed on a computer screen, and/or sent via methods known in the art to other computers and/or users on the Network 180.

At Step 170, Ransomware Monitor 100 may calculate a signature of the suspicious program and/or its filename, so that other computing systems can be proactively warned to search their File System 190 for a matching file. Accordingly, at Step 170, the warning message and/or notification that reports the suspicious program may include the calculated signature.

At Step 170, Ransomware Monitor 100 may shutdown the Operating System 125 to preserve files from further potential damage. As part of the shutdown of Operating System 125, Ransomware Monitor 100 may set or configure the Operating System 125 to restart in “safe” mode (or “single user” mode or similar mode) to reduce further potential damage until the suspicious program that accessed the Bait File 107 can be investigated by other means.

### Benefits and Advantages

Embodiments of the invention may programmatically terminate or kill a suspicious program, as well as all parent processes, and may thereby stop ransomware in its tracks. Such actions can effectively prevent or severely impair any variant of ransomware, or other malicious programs that interact with a Bait File 107, from causing further damage to files in the computing system.

Embodiments of the invention can detect any variant or type of ransomware, whether known or unknown, attempting to encrypt files.

Embodiments of the invention can detect any variant or type of malware attempting to exfiltrate files.

Embodiments of the invention can detect any variant or type of ransomware attempting to delete (wipe) files.

Embodiments of the invention need not rely on the use of a “file signature” to detect ransomware.

Embodiments of the invention can detect active ransomware even if it is missed by conventional antivirus software running on the host machine.

Embodiments of the invention can detect polymorphic ransomware (i.e., code that mutates itself to avoid detection by antivirus software).

Embodiments of the invention are not resource intensive. They do not repeatedly open and scan files to match a file signature, as typical anti-virus products do.

Embodiments of the invention can stop active ransomware attacks from encrypting, exfiltrating, and/or deleting data files.

Embodiments of the invention can benefit any electronic, digital system, computer, phone, or other device that stores digital files and data (System). The ransomware problem is global in nature, thus, the source of customers are global and include individual persons, public and private organizations, businesses, critical infrastructure, and governments who wish to protect their digital data from the ransomware threat and high cost of system recovery or ransom payment.

Embodiments of the invention can terminate both known and unknown variants of ransomware early in the attack. It can also prevent data from being encrypted and/or exfiltrated.

### Computing Device

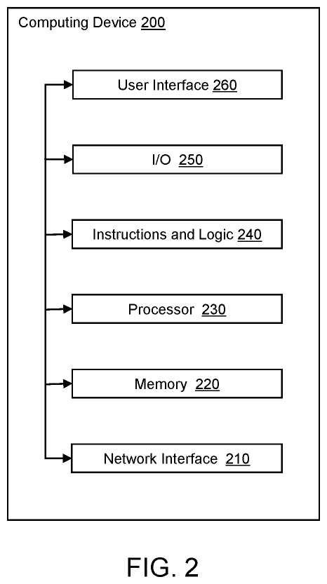

FIG. 2 is a block diagram of an exemplary embodiment of a Computing Device 200, in accordance with the present invention, which in certain operative embodiments can comprise, for example, the Ransomware Monitor 100 of FIG. 1. Computing Device 200 can comprise any of numerous components, such as for example, one or more Network Interfaces 210, one or more Memories 220, one or more Processors 230, program Instructions and Logic 240, one or more Input/Output (“I/O”) Devices 250, and one or more User Interfaces 260 that may be coupled to the I/O Device(s) 250, etc.

Computing Device 200 may comprise any device known in the art that is capable of processing data and/or information, such as any general purpose and/or special purpose computer, including as a personal computer, workstation, server, minicomputer, mainframe, supercomputer, computer terminal, laptop, tablet computer (such as an iPad), wearable computer, mobile terminal, Bluetooth device, communicator, smart phone (such as an iPhone, Android device, or BlackBerry), a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general, any device on which a finite state machine resides that is capable of implementing at least a portion of the methods, structures, API, and/or interfaces described herein may comprise Computing Device 200. Such a Computing Device 200 can comprise components such as one or more Network Interfaces 210, one or more Processors 230, one or more Memories 220 containing Instructions and Logic 240, one or more Input/Output (I/O) Devices 250, and one or more User Interfaces 260 coupled to the I/O Devices 250, etc.

Memory 220 can be any type of apparatus known in the art that is capable of storing analog or digital information, such as instructions and/or data. Examples include a non-volatile memory, volatile memory, Random Access Memory, RAM, Read Only Memory, ROM, flash memory, magnetic media, hard disk, solid state drive, floppy disk, magnetic tape, optical media, optical disk, compact disk, CD, digital versatile disk, DVD, and/or RAID array, etc. The memory device can be coupled to a processor and/or can store instructions adapted to be executed by processor, such as according to an embodiment disclosed herein.

Input/Output (I/O) Device 250 may comprise any sensory-oriented input and/or output device known in the art, such as an audio, visual, and/or haptic device, including, for example, a monitor, display, projector, overhead display, keyboard, keypad, mouse, trackball, joystick, gamepad, wheel, touchpad, touch panel, pointing device, microphone, speaker, video camera, camera, scanner, printer, vibrator, tactile simulator, and/or tactile pad, optionally including a communications port for communication with other components in Computing Device 200.

Instructions and Logic 240 may comprise directions adapted to cause a machine, such as Computing Device 200, to perform one or more particular activities, operations, or functions. The directions, which can sometimes comprise an entity called a “kernel”, “operating system”, “program”, “application”, “utility”, “subroutine”, “script”, “macro”, “file”, “project”, “module”, “library”, “class”, “object”, or “Application Programming Interface,” etc., can be embodied as machine code, source code, object code, compiled code, assembled code, interpretable code, and/or executable code, etc., in hardware, firmware, and/or software. Instructions and Logic 240 may reside in Processor 230 and/or Memory 220.

Network Interface 210 may comprise any device, system, or subsystem capable of coupling an information device to a network. For example, Network Interface 210 can comprise a telephone, cellular phone, cellular modem, telephone data modem, fax modem, wireless transceiver, Ethernet circuit, cable modem, digital subscriber line interface, bridge, hub, router, switch, or other similar device.

Processor 230 may comprise a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can comprise a general-purpose device, such as a microcontroller and/or a microprocessor, such the Pentium IV series of microprocessors manufactured by the Intel Corporation of Santa Clara, California. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.

User Interface 260 may comprise any device and/or means for rendering information to a user and/or requesting information from the user. User Interface 260 may include, for example, at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or another visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, auto-sizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.

The present invention can be realized in hardware, software, or a combination of hardware and software. The invention can be realized in a centralized fashion in one computer system, or in a distributed fashion where different elements are spread across several computer systems. Any kind of computer system or other apparatus adapted for carrying out the methods described herein is suitable. A typical combination of hardware and software can be a general-purpose computer system with a computer program that, when being loaded and executed, controls the computer system such that it carries out the methods described herein.

Although the present disclosure provides certain embodiments and applications, other embodiments apparent to those of ordinary skill in the art, including embodiments that do not provide all of the features and advantages set forth herein, are also within the scope of this disclosure.

The present invention, as already noted, can be embedded in a computer program product, such as a computer-readable storage medium or device which when loaded into a computer system is able to carry out the different methods described herein. “Computer program” in the present context means any expression, in any language, code or notation, of a set of instructions intended to cause a system having an information processing capability to perform a particular function either directly or indirectly after either or both of the following: a) conversion to another language, code or notation; or b) reproduction in a different material form.

The foregoing disclosure has been set forth merely to illustrate the invention and is not intended to be limiting. It will be appreciated that modifications, variations, and additional embodiments are covered by the above teachings and within the purview of the appended claims without departing from the spirit and intended scope of the invention. Other logic may also be provided as part of the exemplary embodiments but are not included here so as not to obfuscate the present invention. Since modifications of the disclosed embodiments incorporating the spirit and substance of the invention may occur to persons skilled in the art, the invention should be construed to include everything within the scope of the appended claims and equivalents thereof.

### Variations

The present invention can be realized in hardware, software, or a combination of hardware and software. The invention can be realized in a centralized fashion in one computing system, or in a distributed fashion where different elements are spread across several computing systems. Any kind of computer system or other apparatus adapted for implementing the limitations described herein is suitable.

Although the present disclosure provides certain embodiments, other embodiments apparent to those of ordinary skill in the art, including embodiments that do not provide all the features and advantages set forth herein, are also within the scope of this disclosure.

The foregoing disclosure has been set forth merely to illustrate the invention and is not intended to be limiting. It will be appreciated that modifications, variations, and additional embodiments are covered by the above teachings and within the purview of the appended claims without departing from the spirit and intended scope of the invention. Other logic may also be provided as part of the exemplary embodiments but are not included here so as not to obfuscate the present invention. Since modifications of the disclosed embodiments incorporating the spirit and substance of the invention may occur to persons skilled in the art, the invention should be construed to include everything within the scope of the appended claims and equivalents thereof.

1. A computer-implemented software method for monitoring files on a computing device to detect and respond to a ransomware attack comprising:
(a) issuing a request to a file system event monitor within the operating system of the computing device to generate a notification event message when an access operation is performed on a bait file located within the file system of the computing device;
(b) upon receiving the notification event message from the file system event monitor:
(b1) obtaining a process identifier associated with the access operation, said process identifier provided within a data structure supplied by file system event monitor with the notification event message;
(b2) determining if a process executing on the computing device and associated with the process identifier is potentially malicious by comparing the process to a list of preapproved software; and
(b3) if the process is determined to be potentially malicious:
(i) issuing a command to the operating system to terminate the process, and
(ii) issuing a command to the operating system to send a warning message reporting an identification of potentially malicious software associated with the process.

2. The method of claim 1, further comprising:
waiting on the notification event.

3. The method of claim 1, further comprising:
installing the bait file on the computing device.

4. The method of claim 3, further comprising:
installing the bait file within a user area of the computing device.

5. The method of claim 3, wherein the name of the bait file suggests it is a user file.

6. The method of claim 3, wherein the name of the bait file is randomly generated.

7. The method of claim 1, wherein the access operation is a read operation.

8. The method of claim 1, wherein the access operation is a delete operation.

9. The method of claim 1, wherein the message reporting an identification of ransomware includes the name of the process associated with the process identifier.

10. The method of claim 1, wherein the certain preapproved software includes an operating system command program.

11. The method of claim 1, wherein the certain preapproved software includes an authorized third-party application.

12. The method of claim 1, further comprising:
increasing the scheduling priority of the monitoring program to the maximum value possible upon receiving the notification event.

13. The method of claim 1, further comprising:
terminating each process in a process tree that includes the process identifier.

14. The method of claim 1, further comprising:
terminating each process in a process group that includes the process identifier.

15. The method of claim 1, further comprising:
calculating a signature of the suspected ransomware.

16. The method of claim 15, further comprising:
transmitting the signature in the warning message over a network.

17. The method of claim 1, further comprising:
shutting down the operating system.

18. The method of claim 17, further comprising:
setting the operating system to reboot into a safe mode.
